(19) United States
(12) Patent Application Publication
(10) Pub. No.: US 2008/0062817 A1
(43) Pub. Date: Mar. 13, 2008

(54) ELECTRICAL AND MECHANICAL TIMER

(75) Inventors: Xihui JIANG, Shenzhen (CN); Shihui XIONG, Shenzhen (CN); Xianfang WANG, Shenzhen (CN); Xiaoyong DONG, Shenzhen (CN); Jianwei LIU, Shenzhen (CN)

Correspondence Address: PEARNE & GORDON LLP, 1801 EAST 9TH STREET, SUITE 1200, CLEVELAND, OH, 44114-3108, US

(73) Assignee: SHENZHEN H&T ELECTRONIC TECHNOLOGY CO., LTD., Shenzhen (CN)

(21) Appl. No.: 11/851,410

(22) Filed: Sep. 7, 2007

(30) Foreign Application Priority Data
Sep. 8, 2006 (CN) 200610062555.4

(51) Int. Cl. G04F 8/00

(52) U.S. Cl. 368/9

(57) ABSTRACT

An electromechanical timer includes a case (1), an electric motor (3) and a unidirectional transmission device (4) disposed in the case. The electric motor is engaged with the unidirectional transmission device, the unidirectional transmission device is connected with a ratchet (5) setting voltages, and the ratchet is fixed with a handle (2). Voltages corresponding to the handle at different rotating positions are collected by a voltage acquisition unit. The voltage acquisition unit outputs the voltages to a control unit. The control unit is connected with the electric motor. The unidirectional transmission device and the ratchet setting voltages realize the random timing at any position.

### BACKGROUND OF THE INVENTION

1. Field of Invention

The present invention relates to a timer, and more particularly to a timer applied in home appliances.

2. Related Art

Currently, most household washing machines include a rotary switch, and a user can turn the rotary switch to realize the timing function. However, the rotary switch has the deficiencies of high cost and low intelligence. That is, the rotary switch cannot realize the timing at any position, and cannot rapidly rotate to the “OFF” position automatically. Moreover, the timing at a position cannot be changed, and the number of timing positions is limited.

### SUMMARY OF THE INVENTION

The technical problem to be solved by the present invention is to overcome the deficiencies in the prior art, and provide an electromechanical timer that realizes free timing.

The technical solution of the present invention to solve the technical problem is described as follows. The electromechanical timer includes a case and an electric motor and a unidirectional transmission device disposed in the case. A shaft of the electric motor is connected with the unidirectional transmission device, the unidirectional transmission device is connected with a ratchet, and the ratchet is fixed with a handle and setting voltages corresponding to different positions of the handle. Voltages of the handle at different positions are collected by a voltage acquisition unit. An output end of the voltage acquisition unit is connected with a control unit and outputs the voltage information to the control unit. An output end of the control unit is connected with the electric motor to adjusting the rotating speed of the motor.

The unidirectional transmission device includes a gear pair and a worm gear pair. The electric motor drives the gear pair, and the gear pair drives a worm in the worm gear pair. The worm gear has a plurality of inner teeth, and an inner tooth space is formed between every two adjacent inner teeth. Mounting slots are formed in the ratchet structure, and an elastic member is disposed in each of the mounting slots to push an urging ball against the inner tooth thereof, and the urging balls are elastically retained in the inner tooth spaces.

The electromechanical timer includes two sets of mounting slots, elastic members, and urging balls. The two mounting slots are coaxial, and are collinear with a diameter of the ratchet.

A code disc is fixed on the handle.

The effective results of the present invention is that the unidirectional transmission device and the ratchet setting voltages information are used to realize the free and random timing at any position.

### BRIEF DESCRIPTION OF THE DRAWINGS

FIG. 1 is a front view of an electromechanical timer of the present invention (without a top cover);

FIG. 2 is a bottom view of the electromechanical timer of the present invention (without the top cover);

FIG. 3 is a schematic structural view of an electric motor and a transmission device of the electromechanical timer of the present invention;

FIG. 4 is an isometric view of the electric motor and the transmission device of the electromechanical timer of the present invention;

FIG. 5 is a cross-sectional view of the electromechanical timer of the present invention;

FIG. 6 is a structural view of a code disc of the electromechanical timer of the present invention; and

FIG. 7 is a front view of the electromechanical timer of the present invention (without the case).

### DETAILED DESCRIPTION OF THE INVENTION

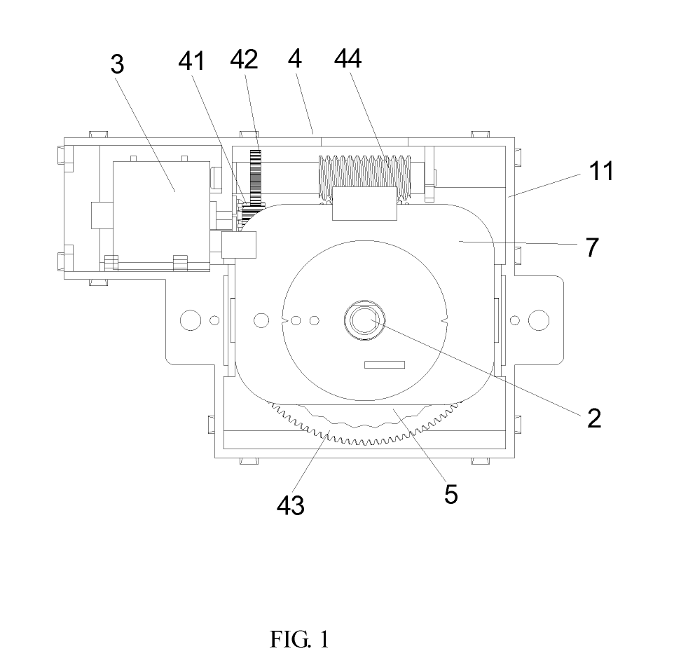

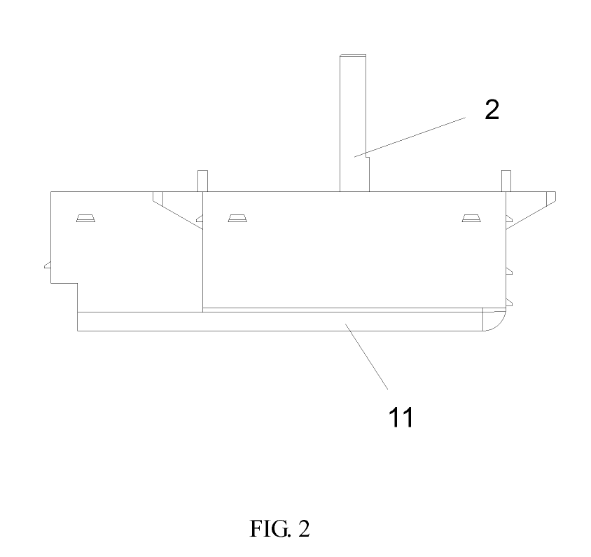

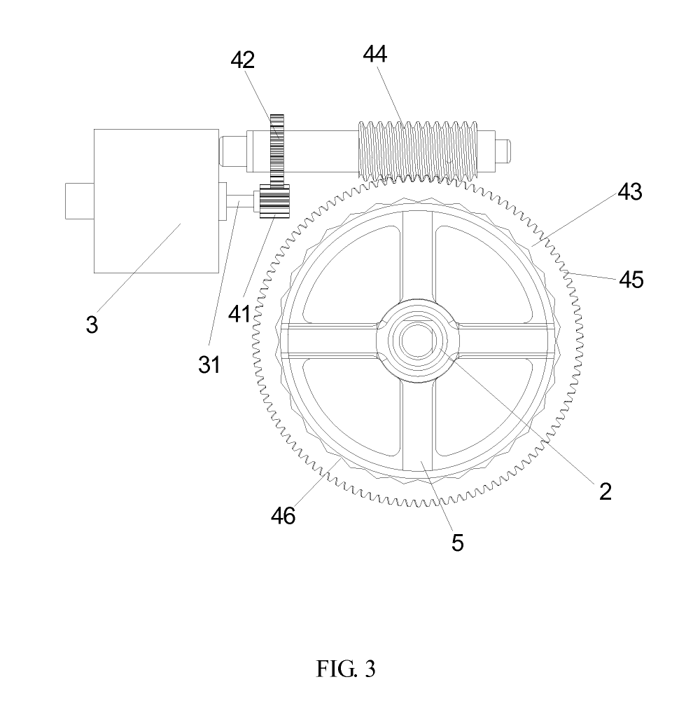

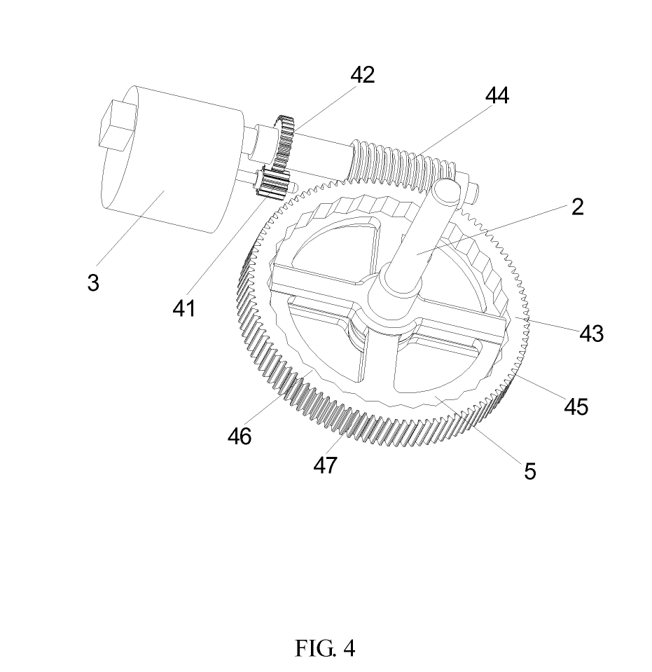

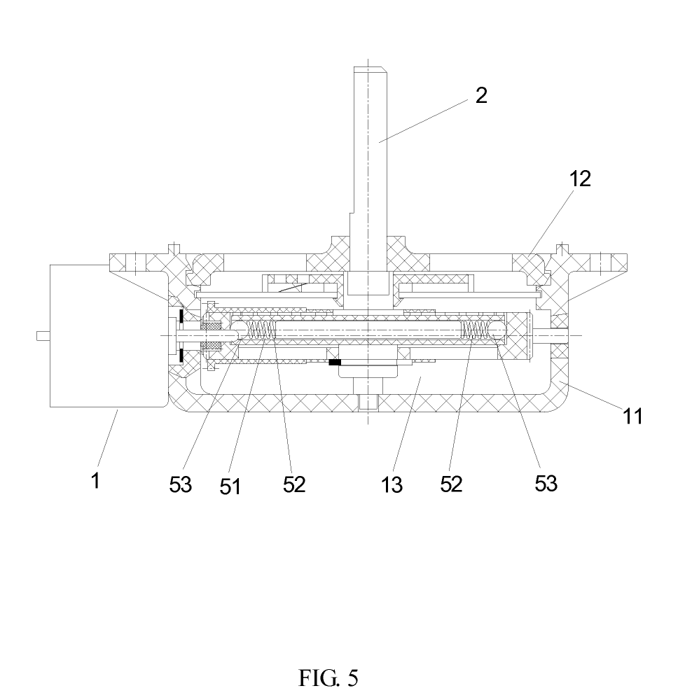

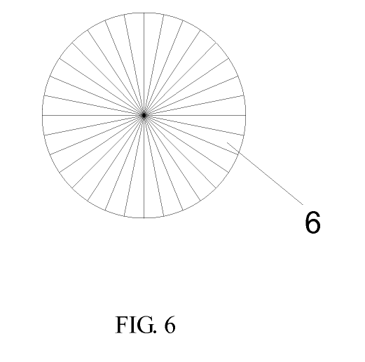

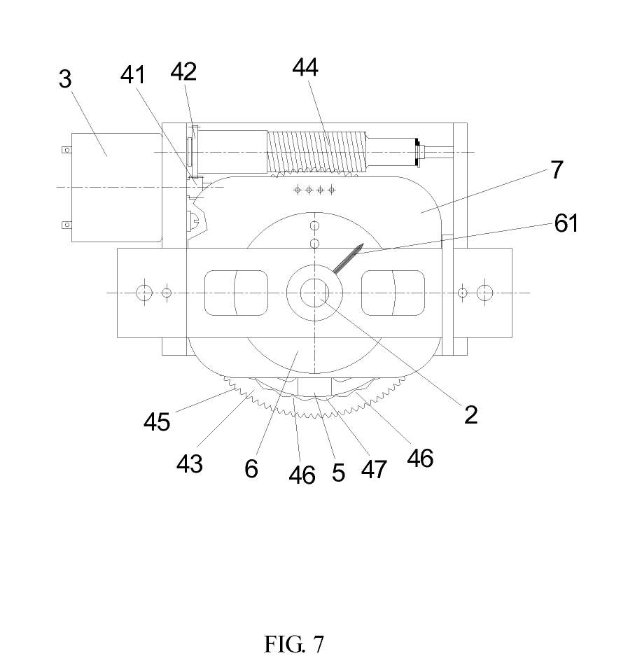

Referring to FIGS. 1-7, the electromechanical timer of the present invention includes a case 1, a handle 2, and an electric motor 3 and a transmission device 4 disposed in the case 1. The case 1 is formed by a housing 11 and a top cover 12. The top cover 12 combines the housing 11, defining a receiving chamber 13 with the housing 11. The electric motor 3 is fixed in the receiving chamber 13, and has a shaft 31. The transmission device 4 includes a first gear 41, a second gear 42, a worm gear 43, and a worm 44. The first gear 41 is smaller than the second gear 42, and the first gear 41 is coaxially fitted on the shaft 31 of the electric motor 3. The second gear 42 is engaged with the first gear 41. The worm 44 is integrately and coaxially formed on the second gear 42. The worm gear 43 is annular-shaped, and has outer teeth 45 and inner teeth 46. The outer teeth 45 are distributed on along the same circumference, and meshes with the worm 44. In the preferred embodiment of the present invention, thirty-two inner teeth 46 are involved, which are evenly distributed along the same circumference at the same angles. An inner tooth space 47 is defined between two adjacent inner teeth 46. Therefore, there are thirty-two inner tooth space 47. The worm gear 43 is engaged with a ratchet 5. The ratchet 5 has two mounting slots 51, which are coaxial with each other and coincide with a diameter of the ratchet 5. A spring 52 is disposed in each of the two mounting slots 51, and an urging ball 53 is disposed at the end of the spring 52 in close proximity to the inner teeth 46 of the worm gear 43. The two urging balls 53 are respectively retained in two inner tooth spaces 47. The handle 2 is integrated with the ratchet 5 and extends out from the case 1, and the handle 2 and the ratchet 5 are coaxial. Moreover, the electromechanical timer further includes a code disc 6 and a circuit board 7. The code disc 6 is fixed on the handle 2, and rotates synchronously with the handle 2. A pointer 61 is disposed on the code disc 6. The circuit board 7 includes a loop circuit formed by connected resistors. Voltages at different nodes corresponding to different positions of the pointer 6 on the code disc 6 are collected by the voltage acquisition unit, A/D converted, and sent to a single chip microcomputer (SCM) to determine the rotating positions (i.e., different positions that the pointer 61 of the code disc 6 points at are corresponding to different nodes on the circuit board, and thus are corresponding to different voltages. In present embodiment, the worm gear 43 has thirty-two inner teeth 46, so the timer has thirty-two timing positions accordingly). After the SCM collects A/D signals of different positions, Starting or stopping of the electric motor 3 is controlled according to an electric motor driving signal output from the SCM, and the rotating speed of the electric motor 3 is adjusted by changing the frequency and the duty ratio of the driving signal, thereby realizing the timing.

When the handle 2 is turned manually, as the worm gear 43 and the worm 44 have the characteristic of unidirectional transmission (if designed reasonably, the rotation can be transmitted from the worm 44 to the worm gear 43, but the rotation cannot be transmitted from the worm gear 43 to the worm 44. This is called the unidirectional transmission characteristic of the worm gear and the worm), the unidirectional transmission direction successively goes handle 2, to ratchet 5, to worm gear 43, to worm 44. Because the worm gear 43 will not drive the worm 44 the worm 44 will remain still and the ratchet 5 overcomes the friction between the urging balls 53 pressed tightly by the springs 52 and the inner teeth 46 of the worm gear 43, thereby rotating with the handle 2. Meanwhile, the ratchet 5 makes a sound like “kaka”. As the worm gear 43 has thirty-two inner teeth corresponding to thirty-two manually selected positions, after a position is selected manually, the timer enters a timing state. In timing state, the transmission device 4 is driven by the electric motor 3, therefore the transmission direction is changed as follows: electric motor 3 goes to first gear 41, first gear 41 goes to second gear 42, second gears 42 goes to worm 44, worm 44 goes to worm gear 46, the worm gear 46 goes to ratchet 5, and the ratchet 5 goes to handle 2.

When the transmission direction is electric motor 3, first gear 41, second gear 42, worm 44, worm gear 4, ratchet 5 and handle 2, the control unit controls the rotating speed, start, and stop of the electric motor 3. The electric motor 3 drives the first gear 41 on the shaft 31 to rotate, and the first gear 41 drives the second gear 42. Therefore, as the worm 44 and the second gear are integrally combined, the worm 44 will rotate with the second gear 42 and drives the worm gear 43 to rotate therealong. The worm gear 43 drives the ratchet 5 together with the handle 2 to rotate by overcoming the friction between the urging balls 53 and the inner teeth 46 of the worm gear 43. According to a program setting time, the ratchet 5 together with the handle 2 stop or keep rotating to the next position.

In this embodiment, the ratchet 5 has thirty-two inner teeth and thirty-two inner tooth spaces 47, and the handle 2 and the ratchet 5 are integrated as a whole, so the handle 2 has thirty-two timing positions too. When the handle 2 rotates to different positions, different voltages are output to the SCM. The SCM accurately determines the position of the handle 2 and the code disc 6 according to different voltages.

In the present invention, the time setting of the electromechanical timer is realized by programming software thereof. When the handle 2 rotates to different positions, corresponding different timing programs are run, so the timing time varies. As there are thirty-two inner teeth, the handle 2 has thirty-two different positions. The thirty-two different positions are corresponding to thirty-two different software programs, thus realizing thirty-two different timings.

The above is only a detailed description on the present invention with reference to a preferred invention, and it shall not be construed that the implementation of the present invention is limited to the description. Persons of ordinary skill in the art can make simple derivations or alternations without departing from the spirit of the present invention, which shall fall into the scope of the present invention defined in the following claims.

What is claimed is:

1. An electromechanical timer, comprising:
a case;
an electric motor; disposed in the case;
a unidirectional transmission device disposed in the case, and engaged with the electric motor, the unidirectional transmission device connected with a ratchet, the ratchet combining a handle, the ratchet setting voltages corresponding positions of the handle; and
a voltage acquisition unit, collecting voltages corresponding to positions of the handle and outputting the voltages to a control unit,
wherein, the control unit is connected with the electric motor, adjusting rotating speed of the electric motor.

2. The electromechanical timer as claimed in claim 1, wherein the unidirectional transmission device comprises a gear pair and a worm gear pair, the electric motor drives the gear pair, and the gear pair drives a worm of the worm gear pair, the worm gear has a plurality of inner teeth, and an inner tooth space is defined between two adjacent inner teeth, mounting slots are formed in the ratchet structure, and an elastic member is disposed in the mounting slots, the elastic member pushes an urging ball against the inner tooth, to keep the urging balls elastically retained in the inner tooth spaces.

3. The electromechanical timer as claimed in claim 2, wherein two sets of mounting slot, elastic member, and urging ball are involved, wherein the two mounting slots are coaxial, and are collinear with a diameter of the ratchet.

4. The electromechanical timer as claimed in claims 1, wherein a code disc is fixed on the handle.
